(19) United States
(12) Patent Application Publication
(10) Pub. No.: US 2021/0006587 A1
(43) Pub. Date: Jan. 7, 2021

(54) SECURITY RISK EVALUATION APPARATUS, SECURITY RISK EVALUATION METHOD, AND COMPUTER READABLE MEDIUM

(71) Applicant: Mitsubishi Electric Corporation, Tokyo (JP)

(72) Inventors: Takumi YAMAMOTO, Tokyo (JP); Hiroki NISHIKAWA, Tokyo (JP); Kiyoto KAWAUCHI, Tokyo (JP)

(73) Assignee: Mitsubishi Electric Corporation, Tokyo (JP)

(21) Appl. No.: 17/028,284

(22) Filed: Sep. 22, 2020

Related U.S. Application Data
(63) Continuation of application No. PCT/JP2018/020182, filed on May 25, 2018.

(51) Int. Cl. H04L 29/06

(52) U.S. Cl. CPC H04L 63/1433

(57) ABSTRACT

A people network detection unit (110) detects, based on public information of a target person, a people network that indicates a connection between the target person and a group of related persons. A disclosure risk calculation unit (120) calculates a disclosure risk of the target person based on the public information of the target person, and calculates a group of disclosure risks corresponding to the group of related persons based on a group of public information corresponding to the group of related persons. A connection risk determination unit (130) determines a representative value of the group of disclosure risks as a connection risk of the target person based on the group of disclosure risks corresponding to the group of related persons. A security risk calculation unit (140) calculates a security risk of the target person with respect to a cyberattack, using the disclosure risk of the target person and the connection risk of the target person.

### CROSS REFERENCE TO RELATED APPLICATIONS

This application is a Continuation of PCT International Application No. PCT/JP2018/020182, filed on May 25, 2018, which is hereby expressly incorporated by reference into the present application.

### TECHNICAL FIELD

The present invention relates to a technology for evaluating a security risk of an individual.

### BACKGROUND ART

Organizations are actively implementing efforts against cyberattacks in order to protect confidential information and assets.

One of them is education or training concerning cyberattacks and security. There are, for example, those to learn knowledge about countermeasures against cyberattacks in a seminar or through e-learning, and those to provide training for dealing with targeted attacks by sending simulated targeted attack e-mails.

However, even though such efforts are implemented, the number of security accidents is increasing steadily.

Non-Patent Literature 1 describes the following. In a fact-finding survey on information leak cases in companies, it was reported that 59% of companies among companies in which information leaks occurred had stipulated security policies and procedures but had not implemented them. It is also pointed out that 87% of information leaks could have been prevented by taking appropriate measures.

From the results of this survey, it can be seen that no matter what level of security countermeasures are introduced, the effect of the security countermeasures strongly depends on persons who implement them.

Non-Patent Literature 2 describes the following. Questionnaires concerning personality and questionnaires concerning security consciousness are correlated, and a causal relationship between personality and security consciousness is created. Based on the created causal relationship, optimal security countermeasures are proposed to each group.

However, since information is collected in a questionnaire format, time and effort are required. In addition, since information difficult to quantify, namely personality, is used, it is difficult to make a well-founded interpretation of the obtained causal relationship.

Non-Patent Literature 3 describes the following. A relationship between behavioral characteristics of users when using computers and psychological characteristics is derived, and behavioral characteristics during regular use of computers are monitored, so as to determine users in psychological states vulnerable to damage.

This method is excellent in that it is not necessary to conduct a questionnaire survey every time. However, since information difficult to quantify, namely psychological states, is used, it is difficult to make a well-founded interpretation of the obtained causal relationship.

### CITATION LIST

### Non-Patent Literature

Non-Patent Literature 1: Verizon Business, 2008 Data Breach Investigations Report, https://www.wired.com/images_blogs/threatlevel/files/databreachreport. pdf?intcid=inline_amp

Non-Patent Literature 2: Yumiko Nakazawa, et al., “Best Match Security—A study on correlation between preference disposition and security consciousness about user authentication—”, Information Processing Society of Japan Technical Report, Vol. 2010-CSEC-48 No. 21

Non-Patent Literature 3: Yoshinori Katayama, et al., “An Attempt to Visualization of Psychological and Behavioral Characteristics of Users Vulnerable to Cyber Attack”, SCIS2015 Symposium on Cryptography and Information Security, 4D1-3

### SUMMARY OF INVENTION

### Technical Problem

It is an object of the present invention to allow a security risk of an individual to be evaluated quantitatively and automatically.

### Solution to Problem

A security risk evaluation apparatus according to the present invention includes:

a people network detection unit to detect, based on public information of a target person, a people network that indicates a connection between a group of related persons and the target person, the group of related persons being one or more related persons each having a direct connection with the target person or having a connection with the target person through at least one person;

a disclosure risk calculation unit to calculate a disclosure risk of the target person based on the public information of the target person, and calculate a group of disclosure risks corresponding to the group of related persons based on a group of public information corresponding to the group of related persons;

a connection risk determination unit to determine a representative value of the group of disclosure risks as a connection risk of the target person based on the group of disclosure risks corresponding to the group of related persons; and

a security risk calculation unit to calculate a security risk of the target person with respect to a cyberattack, using the disclosure risk of the target person and the connection risk of the target person.

### Advantageous Effects of Invention

According to the present invention, a security risk of an individual (target person) can be evaluated quantitatively and automatically.

In addition, since security risks of individuals can be evaluated, a person with a high security risk can be identified.

### BRIEF DESCRIPTION OF DRAWINGS

FIG. 1 is a configuration diagram of a security risk evaluation apparatus 100 in a first embodiment;

FIG. 2 is a configuration diagram of a people network detection unit 110 in the first embodiment;

FIG. 3 is a configuration diagram of a storage unit 190 in the first embodiment;

FIG. 4 is a flowchart of a security risk evaluation method in the first embodiment;

FIG. 5 is a flowchart of a recursive search process in the first embodiment;

FIG. 6 is a diagram illustrating a category table 191 in the first embodiment;

FIG. 7 is a diagram illustrating a people network graph 201 in the first embodiment;

FIG. 8 is a diagram illustrating a people network graph 202 in a third embodiment;

FIG. 9 is a configuration diagram of the security risk evaluation apparatus 100 in a fourth embodiment;

FIG. 10 is a configuration diagram of the storage unit 190 in the fourth embodiment;

FIG. 11 is a flowchart of the security risk evaluation method in the fourth embodiment;

FIG. 12 is a flowchart of a credibility calculation process (S430) in the fourth embodiment;

FIG. 13 is a diagram illustrating a directory graph 211 in the fourth embodiment;

FIG. 14 is a configuration diagram of the security risk evaluation apparatus 100 in a fifth embodiment;

FIG. 15 is a flowchart of the security risk evaluation method in the fifth embodiment; and

FIG. 16 is a hardware configuration diagram of the security risk evaluation apparatus 100 in each of the embodiments.

### DESCRIPTION OF EMBODIMENTS

In the embodiments and drawings, the same elements or corresponding elements are denoted by the same reference sign. Description of elements denoted by the same reference sign will be suitably omitted or simplified. Arrows in the drawings mainly indicate flows of data or flows of processing.

### First Embodiment

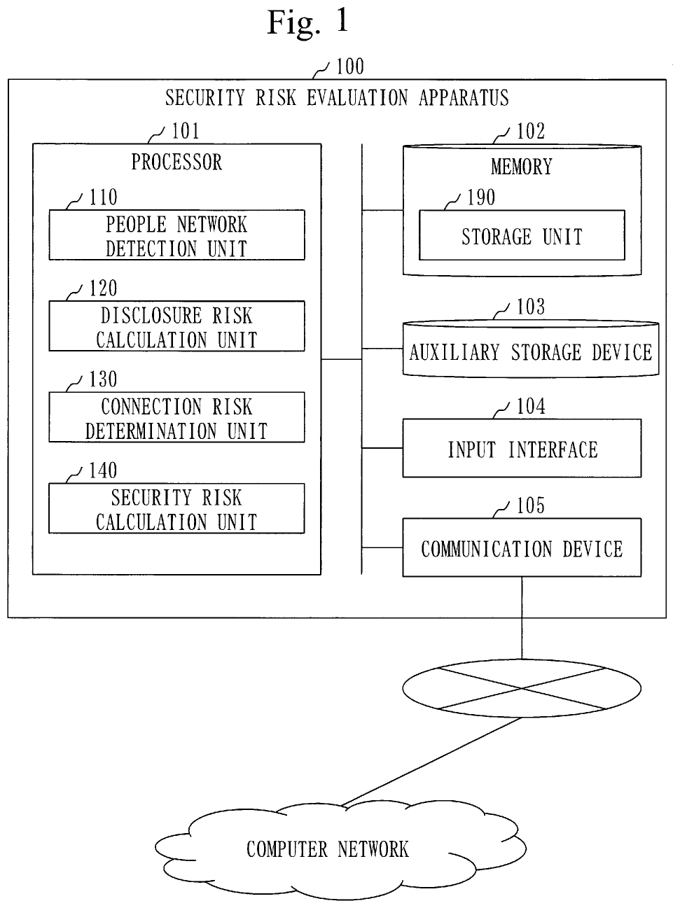

With regard to an embodiment in which a security risk of an individual is calculated quantitatively and automatically, taking into consideration an information disclosure level of the individual and an information disclosure level of a person related to the individual, the embodiment will be described with reference to FIG. 1 to FIG. 7.

### Description of Configuration

Referring to FIG. 1, a configuration of a security risk evaluation apparatus 100 will be described.

The security risk evaluation apparatus 100 is a computer that includes hardware such as a processor 101, a memory 102, an auxiliary storage device 103, an input/output interface 104, and a communication device 105. These hardware components are connected with one another via signal lines.

The processor 101 is an integrated circuit (IC) that performs arithmetic processing, and controls the other hardware components. For example, the processor 101 is a central processing unit (CPU), a digital signal processor (DSP), or a graphics processing unit (GPU).

The memory 102 is a volatile storage device. The memory 102 is also referred to as a main storage device or a main memory. For example, the memory 102 is a random access memory (RAM). Data stored in the memory 102 is saved in the auxiliary storage device 103 as required.

The auxiliary storage device 103 is a non-volatile storage device. For example, the auxiliary storage device 103 is a read only memory (ROM), a hard disk drive (HDD), or a flash memory. Data stored in the auxiliary storage device 103 is loaded into the memory 102 as required.

The input/output interface 104 is a port to which an input device and an output device are connected. For example, the input/output interface 104 is a USB terminal, the input device is a keyboard and a mouse, and the output device is a display. USB is an abbreviation for Universal Serial Bus.

The communication device 105 is a receiver and a transmitter. For example, the communication device 105 is a communication chip or a network interface card (NIC).

The security risk evaluation apparatus 100 includes elements, such as a people network detection unit 110, a disclosure risk calculation unit 120, a connection risk determination unit 130, and a security risk calculation unit 140. These elements are realized by software.

The auxiliary storage device 103 stores a security risk evaluation program for causing a computer to function as the people network detection unit 110, the disclosure risk calculation unit 120, the connection risk determination unit 130, and the security risk calculation unit 140. The security risk evaluation program is loaded into the memory 102 and executed by the processor 101.

The auxiliary storage device 103 further stores an operating system (OS). At least part of the OS is loaded into the memory 102 and executed by the processor 101.

That is, the processor 101 executes the security risk evaluation program while executing the OS.

Data obtained by executing the security risk evaluation program is stored in a storage device, such as the memory 102, the auxiliary storage device 103, a register in the processor 101, or a cache memory in the processor 101.

The memory 102 functions as a storage unit 190. However, another storage device may function as the storage unit 190 in place of the memory 102 or together with the memory 102.

The security risk evaluation apparatus 100 may include a plurality of processors as an alternative to the processor 101. The plurality of processors share the role of the processor 101.

The security risk evaluation program can be computer-readably recorded (stored) in a non-volatile recording medium, such as an optical disc or a flash memory.

The security risk evaluation apparatus 100 is connected to a computer network via the communication device 105.

A specific example of the computer network is the Internet.

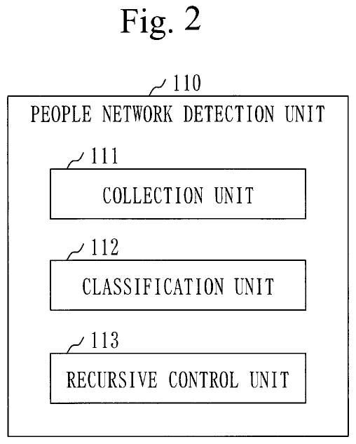

Referring to FIG. 2, a configuration of the people network detection unit 110 will be described.

The people network detection unit 110 includes a collection unit 111, a classification unit 112, and a recursive control unit 113. The functions of these elements will be described later.

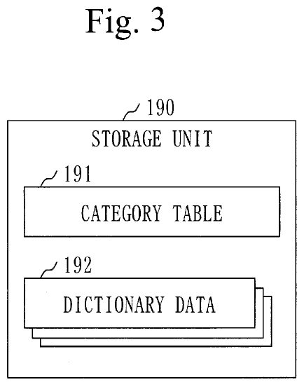

Referring to FIG. 3, a configuration of the storage unit 190 will be described.

The storage unit 190 stores a category table 191 and a plurality of sets of dictionary data 192. The details of these sets of data will be described later.

### Description of Operation

Operation of the security risk evaluation apparatus 100 corresponds to a security risk evaluation method. A procedure for the security risk evaluation method corresponds to a procedure for a security risk evaluation program.

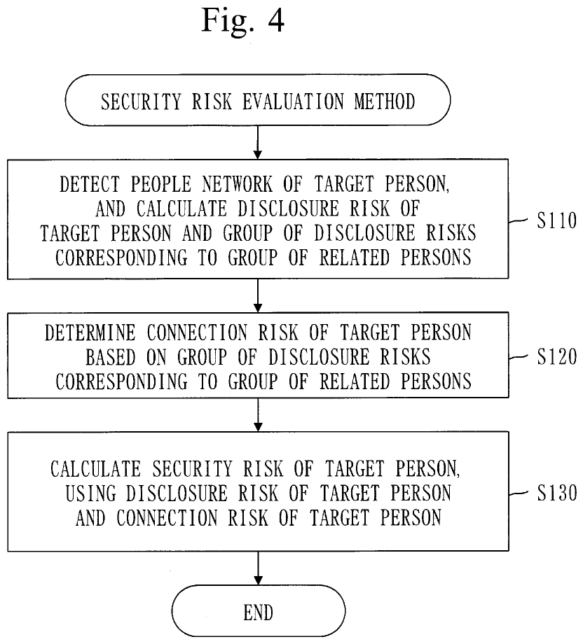

Referring to FIG. 4, the security risk evaluation method will be described.

A person for whom a security risk is evaluated will be referred to as a target person. A person who has a connection with the target person will be referred to as a related person.

In step S110, the people network detection unit 110 detects a people network of the target person based on public information of the target person.

The public information is information published on the computer network.

The people network of the target person indicates connections of the target person with a group of related persons.

The group of related persons is one or more related persons each having a direct connection with the target person or having a connection with the target person through at least one person.

The disclosure risk calculation unit 120 also calculates a disclosure risk of the target person based on the public information of the target person.

The disclosure risk is a security risk in a cyberattack using the public information.

The security risk is a value that represents vulnerability to a cyberattack.

An example of a cyberattack is a targeted attack e-mail.

Furthermore, the disclosure risk calculation unit 120 calculates a group of disclosure risks corresponding to the group of related persons based on a group of public information corresponding to the group of related persons.

Step S110 is realized by a recursive search process.

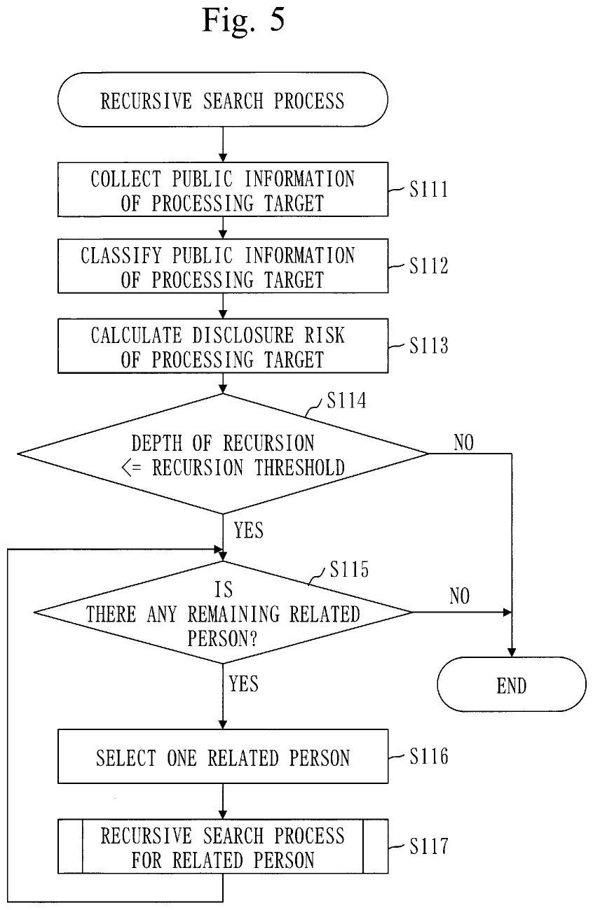

Referring to FIG. 5, the recursive search process will be described.

The recursive search process is performed recursively.

A processing target in the first recursive search process is the target person.

In step S111, the collection unit 111 collects public information of the processing target from the computer network.

For example, the collection unit 111 collects the public information of the processing target based on an identifier of the processing target, using an existing tool for open-source intelligence (OSINT) or an existing search engine. The identifier of the processing target is, for example, a name, an e-mail address, an affiliation, or a combination of these.

In step S112, the classification unit 112 classifies the public information of the processing target into categories.

Specifically, the classification unit 112 classifies the public information of the processing target based on the category table 191 and the plurality of sets of dictionary data 192.

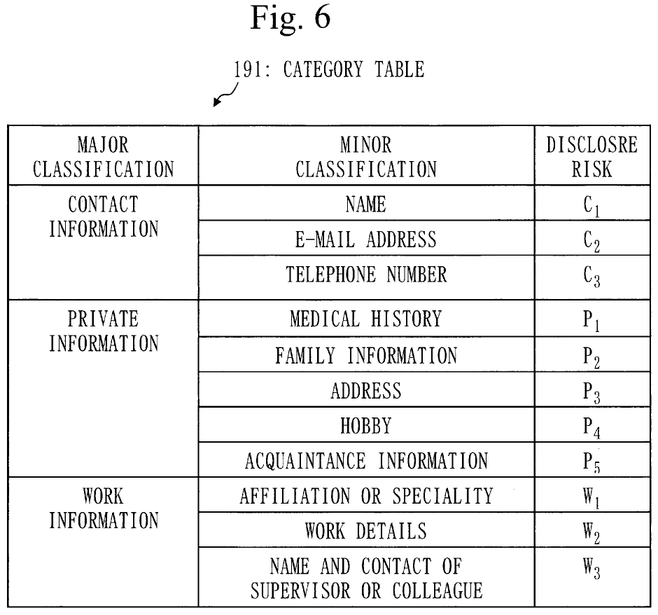

Referring to FIG. 6, the category table 191 will be described.

In the category table 191, a plurality of major classifications, a plurality of minor classifications, and a plurality of disclosure risks are associated with one another.

One major classification is associated with a plurality of minor classifications.

One minor classification is associated with one disclosure risk. That is, a plurality of minor classifications are associated with a plurality of disclosure risks.

A major classification and a minor classification indicate categories.

A disclosure risk indicates the magnitude of a risk when information classified into the category concerned is disclosed.

The plurality of sets of dictionary data 192 will now be described.

Each set of dictionary data 192 is a list of keywords related to a specific category.

For example, one of the plurality of sets of dictionary data 192 is dictionary data 192 concerning personal names.

Operation of the classification unit 112 will now be described.

For each category (minor classification) indicated in the category table 191, the classification unit 112 extracts public information belonging to the category from the public information of the processing target, based on dictionary data 192 corresponding to the category. Then, the classification unit 112 classifies the extracted public information into that category.

Specifically, the classification unit 112 calculates a similarity of the public information with respect to a keyword indicated by the dictionary data 192 corresponding to the category, and compares the similarity of the public information with a similarity threshold. Then, if the similarity of the public information is greater than or equal to the similarity threshold, the classification unit 112 classifies the public information into that category. The similarity can be calculated, for example, using an existing technology such as Word2Vec.

Referring back to FIG. 5, the description of step S112 will be continued.

Based on classification results, the classification unit 112 generates classification result data for the processing target, and stores the classification result data for the processing target in the storage unit 190.

The classification result data indicates the public information in each category.

Furthermore, the classification unit 112 generates a related-person list for the processing target based on classification results of a category concerning related persons.

The related-person list indicates one or more related persons. Specifically, the related-person list indicates a name, affiliation, contact, and the like of each related person.

That is, the classification unit 112 generates the related-person list for the processing target by registering the name, affiliation, contact, and the like of each related person in the related-person list.

Next, step S113 and subsequent steps will be described.

In step S113, the disclosure risk calculation unit 120 calculates a disclosure risk of the processing target based on the classification result data for the processing target.

The disclosure risk calculation unit 120 calculates the disclosure risk of the processing target as described below.

First, the disclosure risk calculation unit 120 calculates a disclosure risk for each category (major classification) based on public information classified into the category. For example, the disclosure risk calculation unit 120 calculates, as a disclosure risk of the major classification, the sum of disclosure risks of minor classifications in each of which at least one piece of public information is classified.

Then, the disclosure risk calculation unit 120 calculates the disclosure risk of the processing target, using the disclosure risks of the individual categories.

For example, the disclosure risk calculation unit 120 calculates a disclosure risk IDR of the processing target by calculating expression [1-1]. Expression [1-1] is a specific example of an expression for calculating the disclosure risk IDR of the processing target.

[Formula 1]

IDR=α·CD+β·PD+γ·WD [1-1]

α+β+γ=1

CD is a disclosure risk concerning contact information.

PD is a disclosure risk concerning private information.

WD is a disclosure risk concerning work information.

$$\begin{matrix}[ Formula 2 ] & \\ CD = {\sum }_{i = 1}^{\vert C \vert} {c}_{i} {x}_{i} \\ {\sum }_{i = 1}^{\vert C \vert} {c}_{i} = 1 \\ {c}_{i} ∈ PR & \end{matrix}$$

Note that xᵢ=1 when information classified into a minor classification i of contact information is disclosed.

Note that xᵢ=0 when information classified into the minor classification i of contact information is not disclosed.

Note that cᵢ is a disclosure risk of the minor classification i of contact information.

|C| is the number of minor classifications of contact information.

PR is a set of positive real numbers.

$$\begin{matrix}[ Formula 3 ] & \\ PD = {\sum }_{i = 1}^{\vert P \vert} {p}_{i} {y}_{i} \\ {\sum }_{i = 1}^{\vert P \vert} {p}_{i} = 1 \\ {p}_{i} ∈ PR & \end{matrix}$$

Note that yᵢ=1 when information classified into a minor classification i of private information is disclosed.

Note that yᵢ=0 when information classified into the minor classification i of private information is not disclosed.

Note that pᵢ is a disclosure risk of the minor classification i of private information.

|P| is the number of minor classifications of private information.

$$\begin{matrix}[ Formula 4 ] & \\ WD = {\sum }_{i = 1}^{\vert W \vert} {w}_{i} {z}_{i} \\ {\sum }_{i = 1}^{\vert W \vert} {c}_{i} = 1 \\ {w}_{i} ∈ PR & \end{matrix}$$

Note that zᵢ=1 when information classified into a minor classification i of work information is disclosed.

Note that zᵢ=0 when information classified into the minor classification i of work information is not disclosed.

Note that wᵢ is a disclosure risk of the minor classification i of work information.

|W| is the number of minor classifications of work information.

In step S114, the recursive control unit 113 checks whether the depth of recursion is smaller than or equal to a recursion threshold.

If the depth of recursion is smaller than or equal to the recursion threshold, the process proceeds to step S115.

If the depth of recursion is greater than the recursion threshold, the recursive search process for the processing target ends.

In step S115, the recursive control unit 113 checks whether there remains any related person who has not been selected in the related-person list for the processing target.

If there remains any related person who has not been selected, the process proceeds to step S116.

If there remains no related person who has not been selected, the recursive search process for the processing target ends.

In step S116, the recursive control unit 113 selects one related person who has not been selected from the related-person list for the processing target.

In step S117, the recursive control unit 113 calls the recursive search process for the related person.

After step S117, the recursive search process is performed using the related person as the processing target.

After the recursive search process for the related person, the process proceeds to step S115.

Referring back to FIG. 4, step S120 will be described.

In step S120, based on the group of disclosure risks corresponding to the group of related persons, the connection risk determination unit 130 determines a representative value of the group of disclosure risks as a connection risk of the target person.

Specifically, the connection risk determination unit 130 determines a maximum disclosure risk in the group of disclosure risks corresponding to the group of related persons as the connection risk of the target person.

For example, the connection risk determination unit 130 determines the connection risk of the target person as described below.

In step S110, the recursive control unit 113 generates a people network graph of the target person by adding a node of the processing target each time the recursive search process is performed. The people network graph of the target person indicates the group of disclosure risks corresponding to the group of related persons.

Then, the connection risk determination unit 130 refers to the people network graph of the target person, and selects a maximum disclosure risk from the group of disclosure risks corresponding to the group of related persons. The selected disclosure risk is the connection risk of the target person.

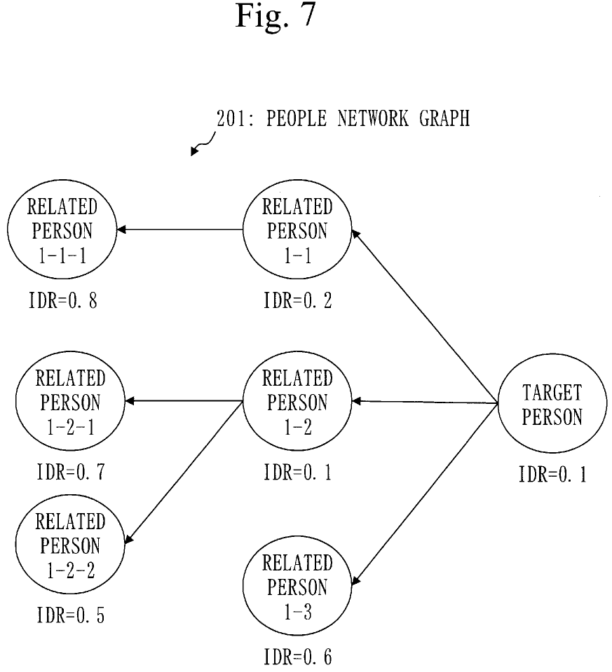

Referring to FIG. 7, a people network graph 201 will be described.

The people network graph 201 is a specific example of the people network graph when the recursion threshold is “2”.

The people network graph has a target-person node and a group of related-person nodes.

The target-person node is a node representing the target person.

The group of related-person nodes is one or more related-person nodes and represents the group of related persons.

One related-person node represents one related person.

Two nodes corresponding two persons who have a direct connection with each other are linked using an arrow. This arrow will be referred to as an edge.

The people network graph has one or more paths originating from the target-person node.

A path is a route from the target-person node to a related-person node at an end.

The people network graph 201 has four paths from the target-person node to four end nodes (1-1-1, 1-2-1, 1-2-2, 1-3).

In the people network graph, the distance from the target-person node to a related-person node is expressed by the number of hops from the target-person node to the related-person node.

In the people network graph 201, the distance from the target-person node to a related-person node (1-1) is “1”, and the distance from the target-person node to a related-person node (1-1-1) is “2”.

In the people network graph, a disclosure risk IDR is added to each node.

The people network graph 201 indicates six disclosure risk IDRs corresponding to the six related persons. The maximum disclosure risk IDR among them is the disclosure risk IDR (=0.8) of a related person 1-1-1.

Therefore, the connection risk determination unit 130 selects the disclosure risk IDR (=0.8) of the related person 1-1-1 as the connection risk of the target person.

A connection risk CR of the target person can be expressed by expression [1-2].

CR=max(IDR(n)) [1-2]

IDR(n) is a disclosure risk IDR of a related-person node n.

The related-person node n satisfies n∈ NODE. NODE is a set of related-person nodes n.

Referring back to FIG. 4, step S130 will be described.

In step S130, the security risk calculation unit 140 calculates a security risk of the target person with respect to a cyberattack, using the disclosure risk of the target person and the connection risk of the target person.

For example, the security risk calculation unit 140 calculates a security risk SR of the target person by calculating expression [1-3].

SR=(ω₁×IDR)+(ω₂×CR) [1-3]

Note that ω₁ is a parameter for adjusting an impact of the disclosure risk IDR.

Note that ω₂ is a parameter for adjusting an impact of the connection risk CR.

### Effects of First Embodiment

A first embodiment allows a security risk of an individual to be calculated quantitatively and automatically, taking into consideration an information disclosure level (disclosure risk) of the individual (target person) and an information disclosure level (connection risks) of a person related to the individual (related person).

### Second Embodiment

With regard to an embodiment in which a connection risk is calculated, taking into consideration a relationship between a target person and a related person, differences from the first embodiment will be mainly described.

### Description of Configuration

The configuration of the security risk evaluation apparatus 100 is the same as the configuration in the first embodiment (see FIG. 1 to FIG. 3).

### Description of Operation The procedure for the security risk evaluation method is the same as the procedure in the first embodiment (see FIG. 4).

However, in step S110, the people network detection unit 110 generates a people network graph of the target person.

For example, the recursive control unit 113 generates the people network graph of the target person by adding a node of the processing target to the people network graph each time the recursive search process is performed.

The people network graph of the target person is as described in the first embodiment.

A specific method for calculating the connection risk of the target person in step S120 is different from the method in the first embodiment.

In step S120, the connection risk determination unit 130 determines the connection risk of the target person based on a group of disclosure risks corresponding to the group of related persons.

Specifically, the connection risk determination unit 130 determines the connection risk of the target person based on the people network graph of the target person as described below.

The connection risk determination unit 130 determines the connection risk of the target person based on the distance from the target-person node to each related-person node in the group of related-person nodes and a disclosure risk of the related person corresponding to each related-person node.

For example, the connection risk determination unit 130 determines the connection risk of the target person as described below.

First, the connection risk determination unit 130 calculates, for each related-person node, an evaluation value of the related-person node concerned, using the distance from the target-person node to the related-person node concerned and the disclosure risk of the related person corresponding to the related-person node concerned.

Then, the connection risk determination unit 130 determines the connection risk of the target person based on a group of evaluation values corresponding to the group of related persons. For example, the connection risk determination unit 130 selects, for each path, a maximum evaluation value from one or more evaluation values in the path concerned. Then, the connection risk determination unit 130 calculates the connection risk of the target person, using one or more maximum evaluation values corresponding to the one or more paths.

For example, the connection risk determination unit 130 calculates a connection risk CR of the target person by calculating expression [2-1].

$$\begin{matrix}[ Formula 5 ] & \\ CR = {\sum }_{path ∈ PATH}^{\vert PATH \vert} {max}_{pn ∈ path} ( \frac{IDR ( on )}{μ \cdot DIST ( pn )} ) & [ 2 \text{-} 1 ]\end{matrix}$$

IDR(n) is a disclosure risk IDR of a related-person node n.

The related-person node n satisfies n∈NODE. NODE is a set of related-person nodes n.

DIST(n) is the distance (number of hops) from the target-person node to the related-person node n.

Note that “path” is a path from the target-person node to a related-person node at an end, and is a set of nodes on the path.

PATH is a set of paths in the people network.

Note that pn is one related-person node included in the path. The related-person node pn satisfies pn∈path.

Note that μ is a parameter for adjusting an impact of the distance.

In FIG. 4, step S130 is as described in the first embodiment.

### Summary of Second Embodiment

In the first embodiment, consideration is given to only the related-person node corresponding to the maximum disclosure risk in the people network.

In actuality, it is considered that a related-person node located at a greater distance from the target-person node in the people network has a smaller impact on the target-person node.

Therefore, in a second embodiment, a connection risk is calculated, taking into consideration the distance of a connection.

### Effects of Second Embodiment

An information disclosure level (connection risk) of a person related to an individual can be calculated, taking into consideration the relationship (distance) between the individual (target person) and the person related to the individual (related person).

### Third Embodiment

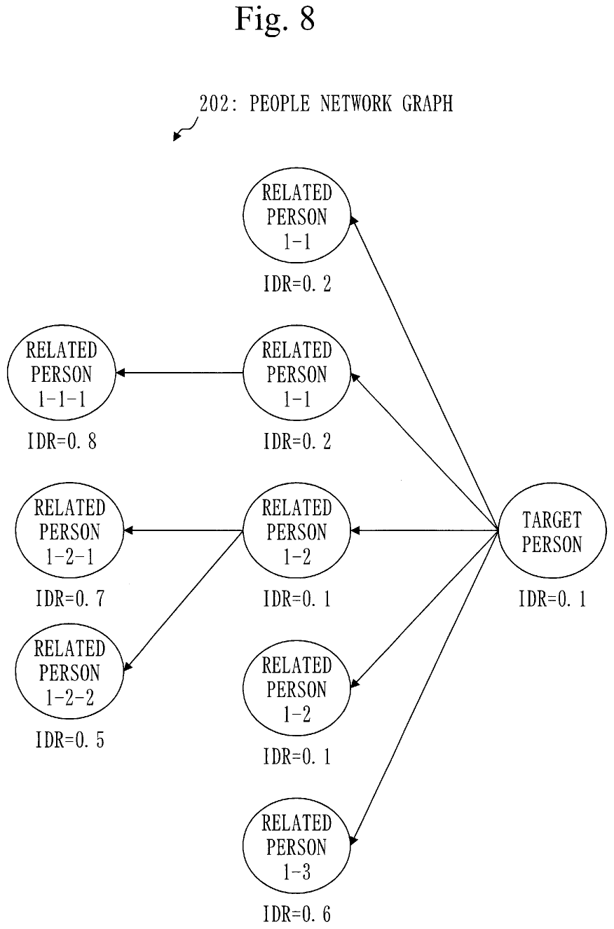

With regard to an embodiment in which a connection risk is calculated, taking into consideration attacks on a target-person node from all related-person nodes, differences from the first embodiment will be mainly described with reference to FIG. 8.

### Description of Configuration

The configuration of the security risk evaluation apparatus 100 is the same as the configuration in the first embodiment (see FIG. 1 to FIG. 3).

### Description of Operation

The procedure for the security risk evaluation method is the same as the procedure in the first embodiment (see FIG. 4).

However, in step S110, the people network detection unit 110 generates a people network graph of the target person.

For example, the recursive control unit 113 generates a provisional people network graph by adding a node of the processing target to the people network graph each time the recursive search process is performed.

The provisional people network graph is the people network described in the first embodiment.

Then, the people network detection unit 110 generates a people network graph of the target person by modifying the provisional people network graph.

The people network graph of the target person has a group of paths corresponding to a group of related-person nodes. That is, the people network graph of the target person has the same number of paths as the number of related persons.

Referring to FIG. 8, a people network graph 202 will be described.

The people network graph 202 is a people network graph obtained by modifying the people network graph 201 (see FIG. 7).

The people network graph 202 has six related-person nodes (1-1, 1-1-1, 1-2, 1-2-1, 1-2-2, 1-3) of six related persons as related-person nodes at ends. Then, the people network graph 202 has six paths corresponding to the six related-person nodes.

Referring back to FIG. 4, the description of the security risk evaluation method in a third embodiment will be continued.

In step S120, a specific method for calculating the connection risk of the target person is different from the method in the first embodiment.

In step S120, the connection risk determination unit 130 determines the connection risk of the target person based on a group of disclosure risks corresponding to the group of related persons.

Specifically, the connection risk determination unit 130 calculates a probability of success of a cyberattack as the connection risk of the target person, using the group of disclosure risks corresponding to the group of related persons.

For example, the connection risk determination unit 130 calculates the connection risk of the target person as described below.

First, the connection risk determination unit 130 calculates, for each path in the people network graph, a probability of failure of a cyberattack in the path concerned, using one or more disclosure risks in the path concerned.

Then, the connection risk determination unit 130 calculates the probability of success of a cyberattack as the connection risk of the target person, using one or more probabilities of failure corresponding to one or more paths.

For example, the connection risk determination unit 130 calculates a connection risk CR of the target person by calculating expression [3-1].

$$\begin{matrix}[ Formula 6 ] & \\ CR = 1 - {\prod }_{path ∈ PATH}^{\vert PATH \vert} ( 1 - {\prod }_{pn ∈ path}^{\vert pn \vert} IDR ( pn ) ) & [ 3 \text{-} 1 ]\end{matrix}$$

Note that “path” is a path from the target-person node to a related-person node at an end and is a set of nodes on the path.

PATH is a set of paths in the people network.

Note that pn is one related-person node included in the path. The related-person node pn satisfies pn∈path.

IDR(pn) is a disclosure risk IDR of the related-person node pn.

The portion indicated as [3-2] included in expression [3-1] denotes the total product of disclosure risk IDR(pn)s in one path and represents a probability of success of an attack on the target person in that path.

[Formula 7]

Π_{pn∈path}^{|pn|}IDR(pn) [3-2]

The portion indicated as [3-3] included in expression [3-1] represents a probability of an attack being unsuccessful in all the paths.

[Formula 8]

Π_{path∈PATH}^{|PATH|}(1−Π_{pn∈path}^{|pn|}IDR(pn)) [3-3]

A probability of an attack being successful in one of the paths can be expressed as a complementary event to the probability [3-3] of an attack being unsuccessful in all the paths.

In FIG. 4, step S130 is as described in the first embodiment.

### Summary of Third Embodiment

In the first embodiment and the second embodiment, consideration is given to attacks on the target-person node from not all related-person nodes in the people network.

In actuality, all related-person nodes have the possibility of becoming the starting point of an attack.

Therefore, in the third embodiment, a disclosure risk of each related-person node is treated as a “probability of success of an attack on a parent node of the related-person node concerned from the related-person node concerned”. Then, a probability of success of an attack on the target-person node is calculated as the connection risk, using disclosure risks of all related-person nodes.

### Effects of Third Embodiment

The third embodiment allows a probability of success of an attack on a target-person node to be calculated as a connection risk, using disclosure risks of all related-person nodes.

### Fourth Embodiment

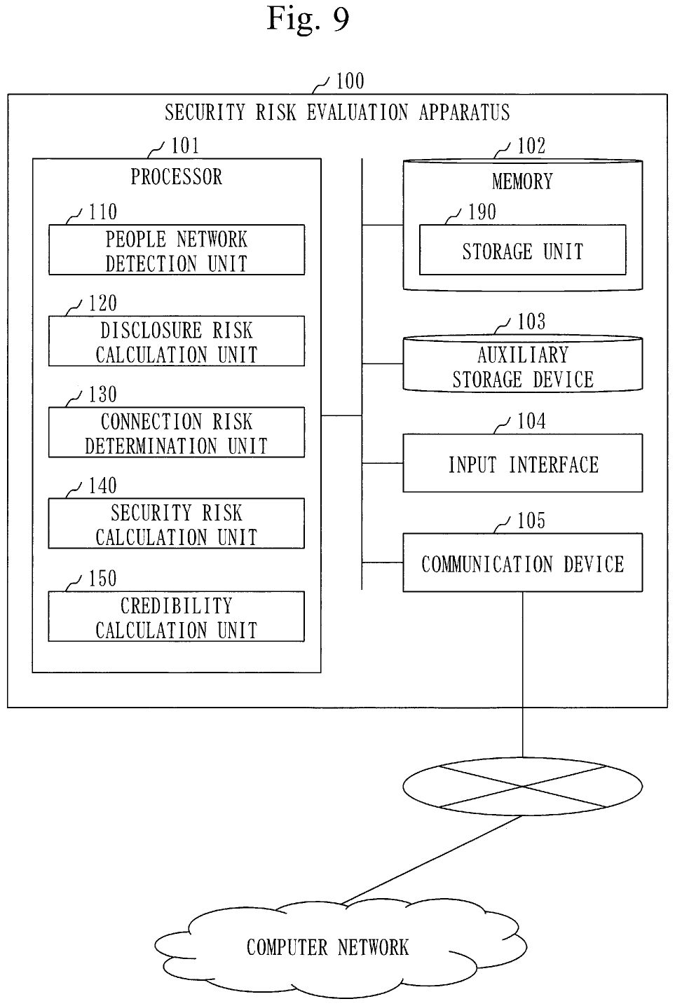

With regard to an embodiment in which a security risk of a target person is calculated, taking into consideration a credibility of a people network, differences from the first embodiment to the third embodiment will be mainly described with reference to FIG. 9 to FIG. 13.

### Description of Configuration

Referring to FIG. 9, a configuration of the security risk evaluation apparatus 100 will be described.

The security risk evaluation apparatus 100 further includes an element named a credibility calculation unit 150. The credibility calculation unit 150 is realized by software.

The security risk evaluation program further causes the computer to function as the credibility calculation unit 150.

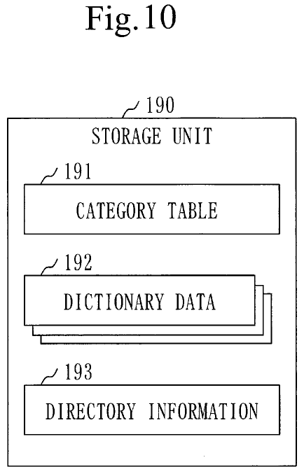

Referring to FIG. 10, a configuration of the storage unit 190 will be described.

The storage unit 190 further stores directory information 193.

The directory information 193 is directory information of an organization to which the target person belongs.

The directory information is what is known as an address book. That is, the directory information of the organization indicates a name, contact, affiliation, role, and the like of each person belonging to the organization.

### Description of Operation

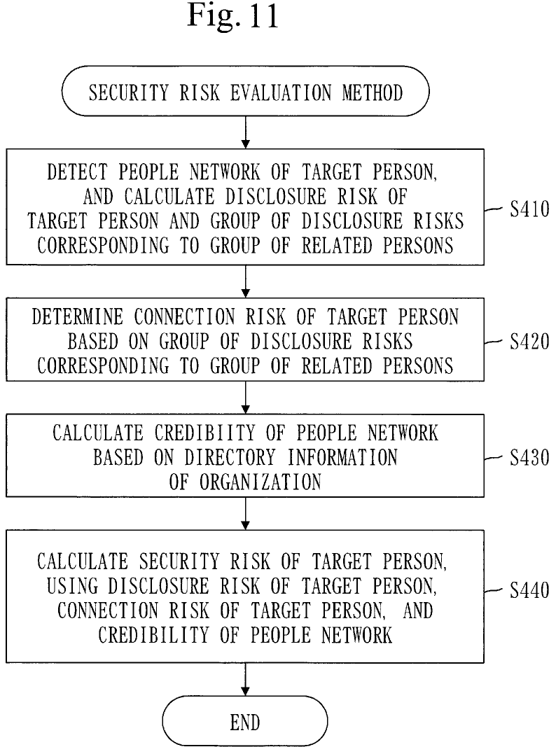

Referring to FIG. 11, the security risk evaluation method will be described.

In step S410, the people network detection unit 110 detects a people network of the target person.

Then, the disclosure risk calculation unit 120 calculates a disclosure risk of the target person and a group of disclosure risks corresponding to a group of related persons.

Step S410 is the same as step S110 in any one of the first embodiment to the third embodiment (see FIG. 4).

In step S420, the connection risk determination unit 130 determines a connection risk of the target person based on the group of disclosure risks corresponding to the group of related persons.

Step S420 is the same as step S120 in any one of the first embodiment to the third embodiment (see FIG. 4).

In step S430, the credibility calculation unit 150 calculates a credibility of the people network of the target person based on the directory information 193.

For example, the credibility calculation unit 150 calculates the credibility of the people network as described below.

First, the credibility calculation unit 150 calculates a rate of related persons included in the directory information 193 among related persons included in the people network. The calculated rate will be referred to as an affiliation rate.

Then, the credibility calculation unit 150 calculates the credibility of the people network, using the affiliation rate. The lower the affiliation rate, the lower the credibility of the people network.

For example, the credibility calculation unit 150 calculates the credibility of the people network as described below.

First, the credibility calculation unit 150 calculates a rate of related persons whose affiliation in the related-person list and affiliation in the directory information 193 match among related persons included in both the people network and the directory information 193. The calculated rate will be referred to as a match rate.

Then, the credibility calculation unit 150 calculates the credibility of the people network, using the match rate. The lower the match rate, the lower the credibility of the people network.

For example, the credibility calculation unit 150 calculates the credibility of the people network as described below.

First, the credibility calculation unit 150 calculates the distance from the node of the target person to the node of each related person based on the people network graph. The calculated distance will be referred to as a relationship distance.

The credibility calculation unit 150 also calculates the distance from the node of the target person to the node of each related person based on a directory graph corresponding to the directory information 193. The calculated distance will be referred to as an organization distance.

Next, the credibility calculation unit 150 calculates the sum of differences between relationship distances and organization distances. The calculated value will be referred to as a total difference.

Then, the credibility calculation unit 150 calculates the credibility of the people network, using the total difference. The larger the total difference, the lower the credibility of the people network.

That is, the credibility calculation unit 150 calculates the credibility of the people network, using the affiliation rate, the match rate, the total difference, or a combination of these.

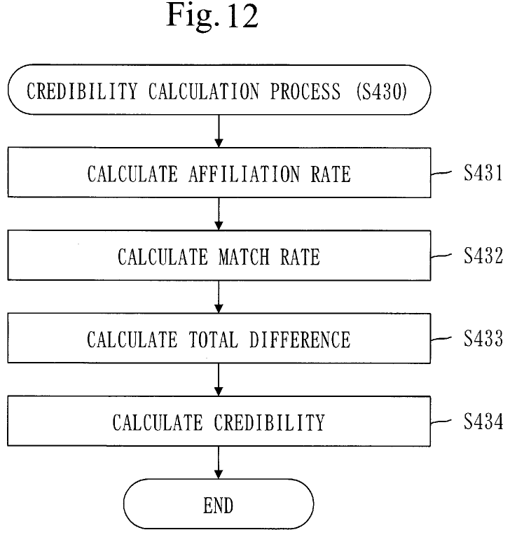

Referring to FIG. 12, a credibility calculation process (S430) in a case in which the credibility is calculated using the affiliation rate, the match rate, and the total difference will be described.

In step S431, the credibility calculation unit 150 calculates an affiliation rate AR based on the related-person list and the directory information 193.

The affiliation rate AR is expressed by expression [4-1].

$$\begin{matrix}[ Formula 9 ] & \\ AR = \frac{\vert NAME \vert}{\vert RP\_NAME \vert} \\ NANE = RP\_NAME ⋂ CP\_NAME & [ 4 \text{-} 1 ]\end{matrix}$$

RP_NAME is a set of related persons in the people network, and |RP_NAME| is the number of elements in the set.

CP_NAME is a set of persons in the directory information, and |CP_NAME| is the number of elements in the set.

In step S432, the credibility calculation unit 150 calculates a match rate MR based on the related-person list and the directory information 193.

The match rate MR is expressed by expression [4-2].

$$\begin{matrix}[ Formula 10 ] & \\ MR = \frac{\vert AFFILIATION\_MATCHED \vert}{\vert NAME \vert} & [ 4 \text{-} 2 ]\end{matrix}$$

AFFILIATION_MATCHED is a set of related persons whose affiliation in the related-person list and affiliation in the directory information match, and |AFFILIATION_MATCHED| is the number of elements in the set.

In step S433, the credibility calculation unit 150 generates a directory graph based on the directory information 193.

The directory graph is a graph representing the people network in the organization to which the target person belongs.

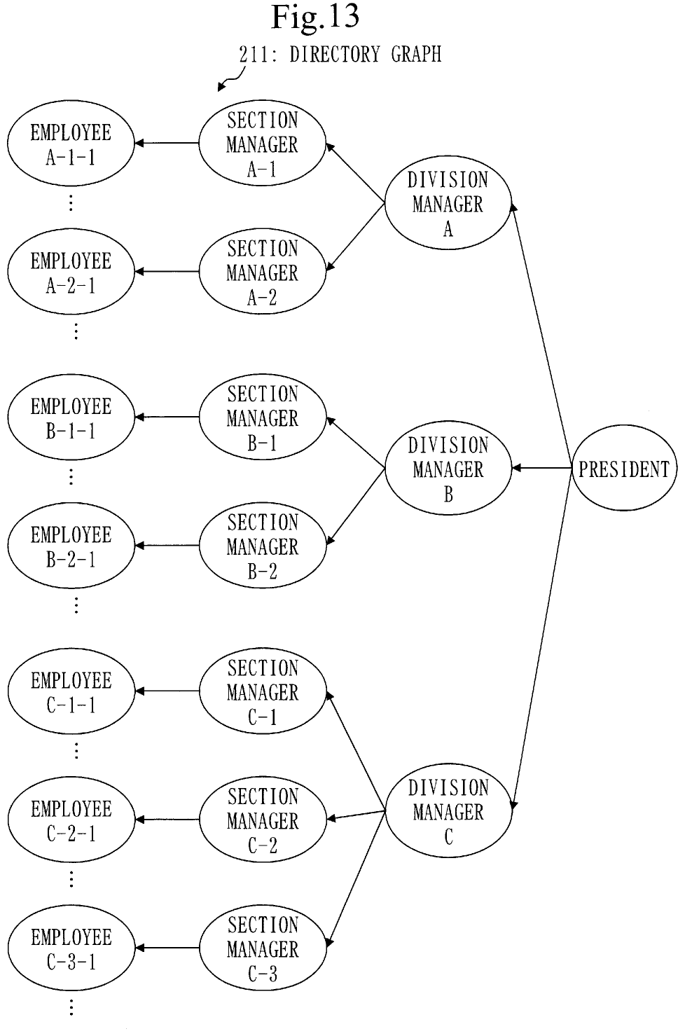

Referring to FIG. 13, a directory graph 211 will be described.

The directory graph 211 is a specific example of the directory graph.

In the directory graph, the distance from the target-person node to a related-person node is expressed by the number of hops from the target-person node to the related-person node.

When the target person is employee A-1-1 and the related person is section manager A-1, the distance from the target-person node to related-person node is “1”.

When the target person is employee A-1-1 and the related person is section manager B-1, the distance from the target-person node to the related-person node is “5”.

When the target person is employee A-1-1 and the related person is employee C-2-1, the distance from the target-person node to the related-person node is “6”.

The distance in a case in which the target-person node and the related-person node has a sibling relationship may be set to “1”. The sibling relationship is a relationship sharing the same parent node.

For example, in the directory graph 211, a parent node of a section manager node (A-1) and a parent node of a section manager node (A-2) are both a division manager node A. Therefore, the section manager node (A-1) and the section manager node (A-2) has a sibling relationship. For this reason, the distance between the section manager node (A-1) and the section manager node (A-2) may be set to “1”.

Referring back to FIG. 12, the description of step S433 will be continued.

The credibility calculation unit 150 calculates a total difference diff by calculating expression [4-3].

$$\begin{matrix}[ Formula 11 ] & \\ diff = {\sum }_{i ∈ NAME}^{\vert NAME \vert} \vert cp\_dist ( x , i ) - rp\_dist ( x , i ) \vert & [ 4 \text{-} 3 ]\end{matrix}$$

Note that cp_dist(x,i) is the distance between a target person x and a person i in the directory graph.

Note that rp_dist(x,i) is the distance between the target person x and the person i in the people network graph.

In step S434, the credibility calculation unit 150 calculates a credibility RE by calculating expression [4-4].

RE=(τ₁×AR)+(τ₂×MR)+(τ₃÷diff) [4-4]

τ₁+τ₂+τ₃=1

Note that τ₁, τ₂, and τ₃ are parameters for adjusting weights of the three measures.

Referring back to FIG. 11, step S440 will be described.

In step S440, the security risk calculation unit 140 calculates a security risk of the target person, using the disclosure risk of the target person, the connection risk of the target person, and the credibility of the people network.

For example, the security risk calculation unit 140 calculates a security risk SR of the target person by calculating expression [4-5].

SR=(ω₁×IDR)+(ω₂×CR×RE) [4-5]

Note that ω₁ is a parameter for adjusting an impact of the disclosure risk.

Note that ω₂ is a parameter for adjusting an impact of the connection risk.

### Summary of Fourth Embodiment

In the first embodiment to the third embodiment, no consideration is given to a level of credibility of the people network.

Therefore, in a fourth embodiment, a credibility of the people network is calculated by comparing directory information of the organization with information on the people network. Then, the credibility of the people network is reflected in a security risk.

### Effects of Fourth Embodiment

The fourth embodiment allows a security risk of a target person to be calculated, taking into consideration a credibility of a people network.

### Fifth Embodiment

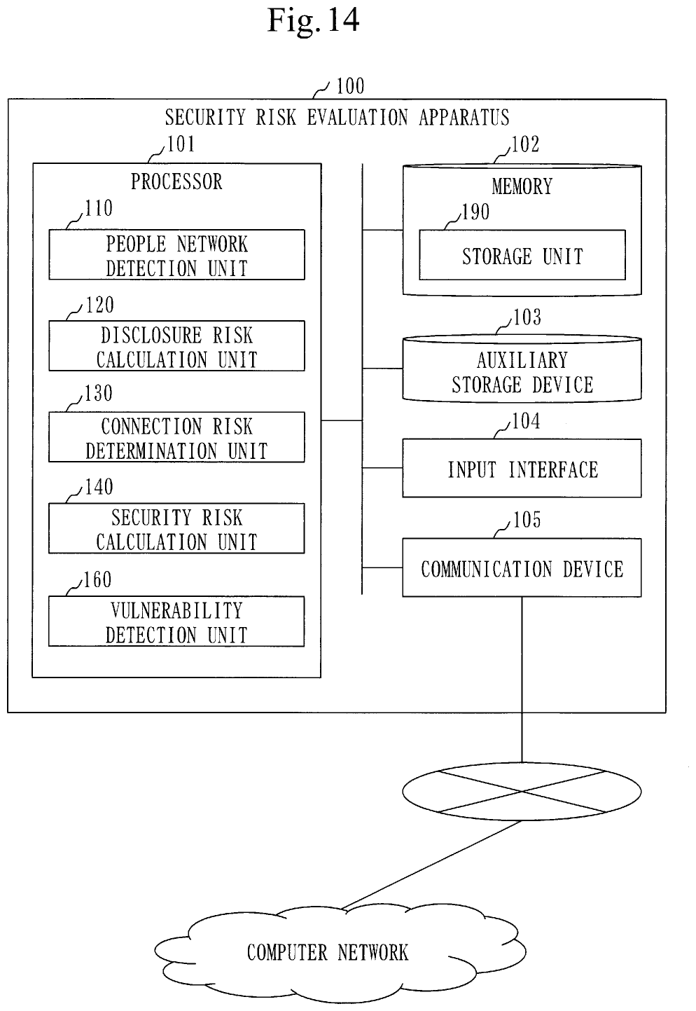

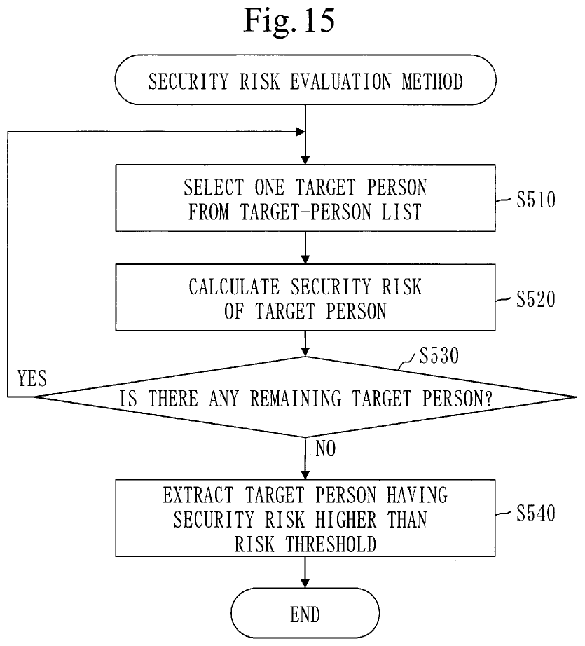

With regard to an embodiment in which a person vulnerable to a cyberattack is found, differences from the first embodiment to the fourth embodiment will be mainly described with reference to FIG. 14 and FIG. 15.

### Description of Configuration

Referring to FIG. 14, a configuration of the security risk evaluation apparatus 100 will be described.

The security risk evaluation apparatus 100 further includes an element named a vulnerability detection unit 160. The vulnerability detection unit 160 is realized by software.

The security risk evaluation program further causes the computer to function as the vulnerability detection unit 160.

The security risk evaluation apparatus 100 may include the credibility calculation unit 150 as in the fourth embodiment.

### Description of Operation

The security risk evaluation method will be described.

The security risk calculation unit 140 calculates a security risk of each of a plurality of target persons.

Then, the vulnerability detection unit 160 finds a vulnerable person with respect to a cyberattack from the plurality of target persons based on a plurality of security risks corresponding to the plurality of target persons.

The vulnerable person with respect to a cyberattack is a person vulnerable to a cyberattack. That is, the vulnerable person with respect to a cyberattack is a person with a low security with respect to a cyberattack.

Referring to FIG. 15, a procedure for the security risk evaluation method will be described.

In step 5510, the vulnerability detection unit 160 selects one target person who has not been selected from a target-person list.

The target-person list indicates one or more target persons. For example, the target-person list indicates a name, affiliation, role, and the like of each target person.

The target-person list is stored in the storage unit 190 in advance. However, the vulnerability detection unit 160 may generate the target-person list based on the directory information 193. In that case, the vulnerability detection unit 160 extracts persons in the organization from the directory information 193, and registers each of the extracted persons as a target person in the target-person list. The range from which persons are extracted can be any range, such as the entire organization, a specific division, or a specific section.

In step S520, the security risk calculation unit 140 calculates a security risk of the selected target person.

Specifically, the security risk of the target person is calculated by performing step S110 to step S130 in any one of the first embodiment to the third embodiment (see FIG. 4).

Alternatively, the security risk of the target person is calculated by performing step S410 to step S440 in the fourth embodiment (see FIG. 11).

In step S530, the vulnerability detection unit 160 checks whether there remains any target person who has not been selected in the target-person list.

If there remains any target person who has not been selected, the process proceeds to step S510.

If there remains no target person who has not been selected, the process proceeds to step S540.

In step S540, the vulnerability detection unit 160 compares the security risk of each target person with a risk threshold, and extracts a target person having a security risk higher than the risk threshold. The extracted target person is a vulnerable person.

Then, the vulnerability detection unit 160 generates a vulnerable-person list, and stores the vulnerable-person list in the storage unit 190. The vulnerable-person list is a list of vulnerable persons.

### Summary of Fifth Embodiment

In the first embodiment to the fourth embodiment, a security risk of a specific person (target person) is calculated.

In a fifth embodiment, a person with a low level of security (person with vulnerability) in an organization is identified, using any one of the first embodiment and the fourth embodiment.

### Effects of Fifth Embodiment

The fifth embodiment allows a vulnerable person (person with a high security risk) in an organization to be efficiently identified.

In addition, the security risk of the entire organization can be lowered by implementing appropriate education or appropriate countermeasures for the identified person.

### Supplementation of Embodiments

It is desirable that the category table 191 and each of the expressions be customized appropriately in the organization in which security risks are evaluated.

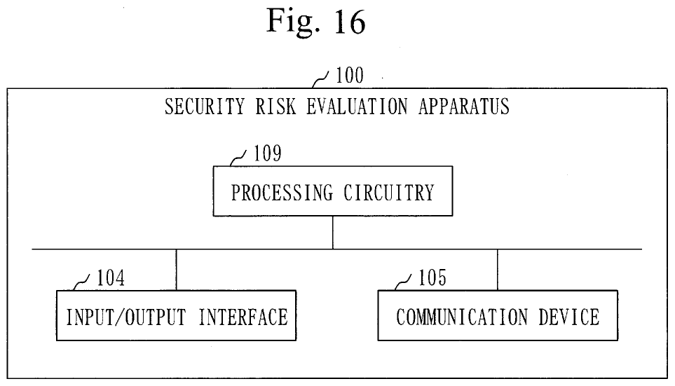

Referring to FIG. 16, a hardware configuration of the security risk evaluation apparatus 100 will be described.

The security risk evaluation apparatus 100 includes processing circuitry 109.

The processing circuitry 109 is hardware that realizes all or some of the people network detection unit 110, the disclosure risk calculation unit 120, the connection risk determination unit 130, the security risk calculation unit 140, the credibility calculation unit 150, and the vulnerability detection unit 160.

The processing circuitry 109 may be dedicated hardware, or may be the processor 101 that executes programs stored in the memory 102.

When the processing circuitry 109 is dedicated hardware, the processing circuitry 109 is, for example, a single circuit, a composite circuit, a programmed processor, a parallel-programmed processor, an ASIC, an FPGA, or a combination of these.

ASIC is an abbreviation for Application Specific Integrated Circuit, and FPGA is an abbreviation for Field Programmable Gate Array.

The security risk evaluation apparatus 100 may include a plurality of processing circuits as an alternative to the processing circuitry 109. The plurality of processing circuits share the role of the processing circuitry 109.

In the processing circuitry 109, some of the functions may be realized by hardware, and the rest of the functions may be realized by software or firmware.

As described above, the processing circuitry 109 can be realized by hardware, software, firmware, or a combination of these.

The embodiments are examples of preferred embodiments, and are not intended to limit the technical scope of the present invention. The embodiments may be implemented partially, or may be implemented in combination. The procedures described using the flowcharts or the like may be suitably changed.

### REFERENCE SIGNS LIST

100: security risk evaluation apparatus; 101: processor; 102: memory; 103: auxiliary storage device; 104: input/output interface; 105: communication device; 109: processing circuitry; 110: people network detection unit; 111: collection unit; 112: classification unit; 113: recursive control unit; 120: disclosure risk calculation unit; 130: connection risk determination unit; 140: security risk calculation unit; 150: credibility calculation unit; 160: vulnerability detection unit; 190: storage unit; 191: category table; 192: dictionary data; 193: directory information; 201, 202: people network graph; 211: directory graph

1. A security risk evaluation apparatus comprising:
processing circuitry to:
detect, based on public information of a target person, a people network that indicates a connection between a group of related persons and the target person, the group of related persons being one or more related persons each having a direct connection with the target person or having a connection with the target person through at least one person;
calculate a disclosure risk of the target person based on the public information of the target person, and calculate a group of disclosure risks corresponding to the group of related persons based on a group of public information corresponding to the group of related persons;
determine a representative value of the group of disclosure risks as a connection risk of the target person based on the group of disclosure risks corresponding to the group of related persons; and
calculate a security risk of the target person with respect to a cyberattack, using the disclosure risk of the target person and the connection risk of the target person.

2. The security risk evaluation apparatus according to claim 1,
wherein the processing circuitry determines a maximum disclosure risk among the group of disclosure risks corresponding to the group of related persons as the connection risk of the target person.

3. The security risk evaluation apparatus according to claim 1,
wherein the processing circuitry generates a people network graph that has a target-person node representing the target person and a group of related-person nodes representing the group of related persons and represents the people network, and
determines the connection risk based on a distance from the target-person node to each related-person node of the group of related-person nodes and a disclosure risk of a related person corresponding to each related-person node.

4. The security risk evaluation apparatus according to claim 3,
wherein the processing circuitry calculates, for each related-person node, an evaluation value of the related-person node concerned, using a distance from the target-person node to the related-person node concerned and a disclosure risk of a related person corresponding to the related-person node concerned, and determines the connection risk based on a group of evaluation values corresponding to the group of related-person nodes.

5. The security risk evaluation apparatus according to claim 4,
wherein the people network graph has one or more paths originating from the target-person node, and
wherein the processing circuitry selects, for each path, a maximum evaluation value from one or more evaluation values in the path concerned, and calculates the connection risk, using one or more maximum evaluation values corresponding to the one or more paths.

6. The security risk evaluation apparatus according to claim 1,
wherein the processing circuitry calculates a probability of success of a cyberattack as the connection risk of the target person, using the group of disclosure risks corresponding to the group of related persons.

7. The security risk evaluation apparatus according to claim 6,
wherein the processing circuitry generates a people network graph that has a target-person node representing the target person, a group of related-person nodes representing the group of related persons, and a group of paths corresponding to the group of related-person nodes and represents the people network, and
calculates, for each path in the people network graph, a probability of failure of a cyberattack in the path concerned, using one or more disclosure risks in the path concerned, and calculates the probability of success as the connection risk, using one or more probabilities of failure corresponding to the one or more paths.

8. The security risk evaluation apparatus according to claim 1,
wherein the processing circuitry calculates a credibility of the people network based on directory information of an organization to which the target person belongs, and
calculates the security risk of the target person, using the disclosure risk of the target person, the connection risk of the target person, and the credibility of the people network.

9. The security risk evaluation apparatus according to claim 8,
wherein the processing circuitry calculates, as an affiliation rate, a rate of related persons included in the directory information among the related persons included in the people network, and calculates the credibility, using the affiliation rate.

10. The security risk evaluation apparatus according to claim 8,
wherein the processing circuitry generates a related-person list that indicates an affiliation of each of the related persons included in the people network based on the public information of the target person, and
calculates, as a match rate, a rate of related persons whose affiliation in the related-person list and affiliation in the directory information match among related persons included in both the people network and the directory information, and calculates the credibility, using the match rate.

11. The security risk evaluation apparatus according to claim 8,
wherein the processing circuitry calculates a distance from a node of the target person to a node of each related person as a relationship distance based on a people network graph representing the people network, calculates a distance from the node of the target person to the node of each related person as an organization distance based on a directory graph corresponding to the directory information, calculates a total sum of differences between relationship distances and organization distances as a total difference, and calculates the credibility, using the total difference.

12. The security risk evaluation apparatus according to claim 1,
wherein the processing circuitry calculates a security risk of each of a plurality of target persons, and
finds a vulnerable person with respect to a cyberattack from the plurality of target persons based on a plurality of security risks corresponding to the plurality of target persons.

13. A security risk evaluation method comprising:
detecting, based on public information of a target person, a people network that indicates a connection between a group of related persons and the target person, the group of related persons being one or more related persons each having a direct connection with the target person or having a connection with the target person through at least one person;
calculating a disclosure risk of the target person based on the public information of the target person, and calculating a group of disclosure risks corresponding to the group of related persons based on a group of public information corresponding to the group of related persons;
determining a representative value of the group of disclosure risks as a connection risk of the target person based on the group of disclosure risks corresponding to the group of related persons; and
calculating a security risk of the target person with respect to a cyberattack, using the disclosure risk of the target person and the connection risk of the target person.

14. A non-transitory computer readable medium storing a security risk evaluation program for causing a computer to execute:
a people network detection process of detecting, based on public information of a target person, a people network that indicates a connection between a group of related persons and the target person, the group of related persons being one or more related persons each having a direct connection with the target person or having a connection with the target person through at least one person;
a disclosure risk calculation process of calculating a disclosure risk of the target person based on the public information of the target person, and calculating a group of disclosure risks corresponding to the group of related persons based on a group of public information corresponding to the group of related persons;
a connection risk determination process of determining a representative value of the group of disclosure risks as a connection risk of the target person based on the group of disclosure risks corresponding to the group of related persons; and
a security risk calculation process of calculating a security risk of the target person with respect to a cyberattack, using the disclosure risk of the target person and the connection risk of the target person.
